(19) United States
(12) Patent Application Publication
(10) Pub. No.: US 2006/0267328 A1
(43) Pub. Date: Nov. 30, 2006

(54) Clamping device for the steering column of a motor vehicle

(76) Inventors: Fred Eggers, BuXtehude (DE); Torsten Harms, Hamburg (DE); Holger Kittler, Hamburg (DE); Sven Sagner, Hamburg (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/553,813

(22) PCT Filed: Feb. 17, 2004
(86) PCT No.: PCT/EP04/01467

§ 371 Date: Jul. 17, 2006

(30) Foreign Application Priority Data
Apr. 19, 2003 (DE) 103 18 034.6

(51) Int. Cl. B62D 1/18

(52) U.S. Cl. 280/775; 74/493

(57) ABSTRACT

The invention relates to a clamping device (1) for the steering column of a motor vehicle, said device (1) comprising two jaw-shaped components (2, 3) running vertically parallel to one another, between which a casing tube of the steering column extends and which have two opposing through-openings (7). The device (1) further comprises a clamping bolt (6), which passes through the through-openings (7) and interacts by tensioning with a counter-element (8) in order to apply the clamping force, the bolt head being arranged on sides of the exterior (10) of the one jaw-shaped component (2) and the counter-element (8) on sides of the exterior (11) of the other jaw-shaped component (3). In order to permit an adequate retaining force acting on the casing tube, despite the simplified design of the clamping device (1), one jaw-shaped component (2) is of elastically flexible design, at least in the thickness direction, and another jaw-shaped component (3) is of flexurally rigid design, at least in the thickness direction.

### CROSS REFERENCE TO RELATED APPLICATION

This application is a national stage of PCT/EP2004/001467 filed Feb. 17, 2004 and based upon DE 103 18 034.6 filed Apr. 19, 2003 under the International Convention.

### BACKGROUND OF THE INVENTION

1. Field of the Invention

The invention relates to a clamping device for the steering column of a motor vehicle.

2. Related Art of the Invention

A clamping device of the generic type is disclosed by EP 0 802 104 B1. This describes a steering column having a clamping device in which two parallel legs running vertically downwards project on a mounting bracket, which is fitted to a body part of a motor vehicle. The legs have through-holes, through which a retaining bolt passes on the one hand and a tensioning bolt on the other. Overlapping stacks of shims, some of which are composed of metal shims running basically vertically, and others of metal shims running basically horizontally, are arranged on the bolts next to the outsides of the legs. The shims are arranged in alternately sandwiched layers and have elongated holes, which overlap one another. In this overlap area the tensioning bolt passes through the elongated holes, which serve to ensure that the steering column is longitudinally and height-adjustable within specific limits. The through-holes in the legs, which coincide with the elongated holes in the shims, take the form of correspondingly intersecting elongated holes. The metal shims running horizontally are fixed at both ends to the casing tube, so that once the tensioning bolt has been tightened with a lock nut a clamping force is exerted on the casing tube via the ends of the shims running horizontally. The known clamping device is of a complicated, multipart design and very expensive to manufacture.

### SUMMARY OF THE INVENTION

The object of the invention is to develop a clamping device of the generic type further, so that despite simplification of its design it will nevertheless permit an adequate clamping force on the casing tube, thereby affording sufficient retaining force for fixing the position of the casing tube to withstand improper use and operating forces.

The particular design of the two jaw-shaped components, affording both rigidity on the one hand and elasticity on the other, means that the casing tube can readily be clamped in a defined position simply between the two components by tightening the tensioning bolt in conjunction with a counter-element. No additional components are required in order to ensure an adequate clamping function. At the same time a sufficient retaining force is achieved for fixing the position of the casing tube to withstand improper use or operating forces.

### BRIEF DESCRIPTION OF THE DRAWINGS

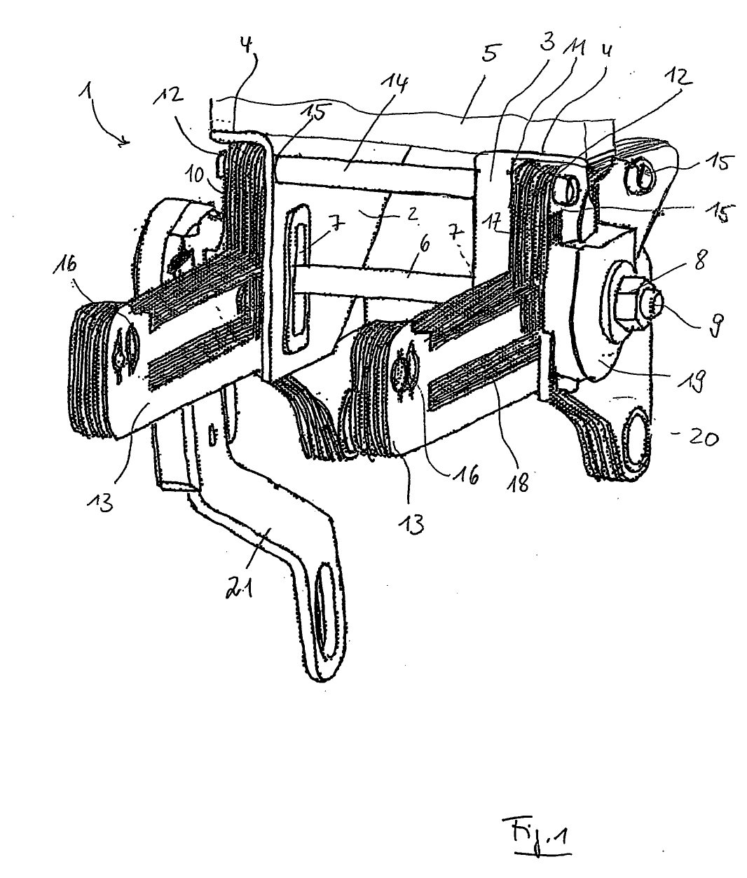

The invention is described in more detail below with reference to one exemplary embodiment represented in the drawing, in which FIG. 1 shows a perspective view of a clamping device according to the invention, omitting a clamped casing tube.

### DETAILED DESCRIPTION OF THE INVENTION

FIG. 1 represents a clamping device 1 for the steering column of a motor vehicle, the device 1 comprising two jaw-shaped components 2, 3, hereinafter referred to as clamping jaws, running vertically parallel to one another. The clamping jaws 2, 3 may readily be fitted, in particular bolted or welded directly to the body of the vehicle. For this purpose, however, the corresponding sheet metal or hollow section body member must be suitably designed in order to afford a fixing surface, on which the jaws can be reliably and durably mounted. A complex adaptation of the fixing surfaces 4 of the clamping jaws 2, 3 to the body configuration is also feasible. Alternatively the clamping jaws 2, 3 may also be fixed to a mounting bracket 5, which is itself firmly fixed to the vehicle. This makes for a simpler design of the horizontally bent fixing surfaces 4 of the clamping jaws 2, 3, which now need no longer be adapted to the corresponding mating surfaces of the body, but may be of plane design. Furthermore, when bolting to the mounting bracket 5 through elongated holes in the latter, the clamping jaws 2, 3 can thereby be adjusted in the longitudinal direction of the steering column casing tube, thereby on the one hand serving to compensate for the production tolerances of the clamping jaws 2, 3, which may impede or even completely prevent the ready insertion of a clamping bolt 6 right through aligning through-openings 7 of the clamping jaws 2, 3. On the other hand, the position of the clamping jaws 2, 3 can easily be adjusted to steering columns of different designs.

The clamping bolt 6 passes through the through-openings 7 in the clamping jaws 2, 3 and once the bolt 6 has been tightened interacts by tensioning with a counter-element 8 in the form of a nut in order to apply the clamping force, the bolt 6 on its outer circumference, at least at one end 9, carrying a thread that mates with the internal thread of the nut. The bolt head is placed on sides of the exterior 10 of the clamping jaw 2 and the counter-element 8 on sides of the exterior 11 of the clamping jaw 3. In order to be able to clamp the steering column casing tube (not shown here), which extends between the clamping jaws 2, 3, the clamping jaw 2 is of elastically flexible design in the direction of its thickness, that is to say in the longitudinal direction of the clamping bolt 6, whereas the clamping jaw 3 is of flexurally rigid design in the direction of its thickness and thereby forms a rigid datum component, against which the casing tube can be securely fastened, giving the casing tube a stable, defined lateral position. The flexible characteristics of the clamping jaw 2 on the one hand and the flexurally rigid characteristics of the clamping jaw 3 on the other may be achieved, for example, through the deliberate selection of different materials, whilst the wall thickness of the two clamping jaws 2, 3 may well be identical, which can save overall space. Furthermore, as an alternative to being made of the same material, or in addition to the choice of different materials, the two clamping jaws 2, 3 may be made so that the flexurally rigid clamping jaw 3 is provided with a correspondingly large wall thickness and the flexible clamping jaw 2 with a correspondingly small wall thickness. The facilities for varying the wall thickness and the use of material mean that the clamping force can be tailored to requirements over a relatively wide range. The selection of one single material for both clamping jaws 2, 3 and the defining of different wall thicknesses with a specific view to the respective predetermined functions of the clamping jaws 2, 3 represent a cost-effective variant.

As already mentioned, the clamping bolt 6 passes through the opposing through-openings 7 of the clamping jaws 2, 3. In the fitted position of the casing tube the clamping bolt 6 may run beneath the casing tube or may pass through suitable openings in the latter. The through-openings 7 here take the form of elongated holes running basically vertically, which when the clamping of the clamping device 1 is slackened permits height adjustment of the steering column.

A stack of thin metal shims 12, 13 is arranged between the bolt head and exterior 10 of the clamping jaw 2 and between the nut and the exterior 11 of the clamping jaw 3 respectively, the shims 12 running basically vertically and the shims 13 basically horizontally. The shims 12, 13 are stacked alternately in a sandwich-like configuration, the shims 12 being held, rotationally fixed to the clamping jaws 2, 3, by means of two spaced support bolts 14 lying parallel and at approximately the same height and passing transversely through said jaws in the area of their fixing surfaces 4. For this purpose the shims 12 have through-openings 15 for the bolt 14. The shims 13 in turn have fixing openings 16 at both ends, through which a locking bolt passes, which at the same time passes through the casing tube in corresponding openings, so that the shims 13 are secured to the casing tube. The shims 12, 13 are elastically deformable in a transverse direction. Given the presence of such shim stacks, tightening the clamping bolt 6 increases the retaining force acting on the casing tube and distributes it over a wider area, the horizontal shims 13 being fixed at their ends to the casing tube and thereby generating an additional retaining force. The elastic flexibility of the shims 12, 13, means that when clamping is applied a frictional system is created between the shims 12, 13 and the casing tube, and the more or less intimate contact formed by the shims 12, 13 as they bear against the casing tube results in a virtually positive interlocking fit, the overall effect of which is to increase the clamping force translated into retaining force acting on the casing tube.

In addition the shims 12, 13 have elongated hole-like elongated slots 17, 18, the elongated slots 17 in the shims 12 being aligned vertically and the elongated slots 18 in the shims 13 running in their longitudinal direction. The elongated slots 17 and 18 intersect in the area of the through-openings 7 in the clamping jaws 2, 3, clamping bolts 6 likewise passing through said slots. The elongated slots 17, which coincide with the through-openings 7, serve for the practical realization of the theoretically feasible height adjustment of the steering column when a stack of shims is arranged on the exterior of the clamping jaws 2, 3. The elongated slots 18 in the shims 13 afford the facility for longitudinal adjustment of the steering column.

The clamping device further comprises a pressure distributing plate 19, which is arranged between the counter-element 8 and the exterior 20 of an outer shim 12 and through which the clamping bolt 6 passes, the plate 19, after tightening of the counter-element 8, being pressed against the shims 12. In the process, the clamping force is in addition widely distributed, so that an improved clamping of the casing tube is achieved. On the opposite side of the pressure distributing plate 19 a lever 21, which on the one hand during assembly facilitates handling when clamping and on the other serves, when required, to slacken the clamping so that the casing tube can be adjusted, acts on the bolt head. The rotational torque of the lever 21 is in the process converted into an axial motion with an axial clamping force.

1. A clamping device for the steering column of a motor vehicle, said device comprising
first and second jaw-shaped components running vertically parallel to one another, between which a casing tube of the steering column extends and which have two opposing through-openings, and
a clamping bolt, which passes through the through-openings and interacts by tensioning with a counter-element in order to apply the clamping force, the bolt head being arranged on sides of the exterior of the first jaw-shaped component and the counter-element on sides of the exterior of the second jaw-shaped component, wherein
one jaw-shaped component (2) is of elastically flexible design, at least in the thickness direction, and the other jaw-shaped component (3) is of flexurally rigid design, at least in the thickness direction.

2. The device as claimed in claim 1, wherein the two components (2, 3) are made from the same material, the flexurally rigid component (3) being designed with a correspondingly large wall thickness and the elastically flexible component (2) with a correspondingly small wall thickness.

3. The device as claimed in claim 1, wherein the two components (2, 3) are fitted to the body of the vehicle.

4. The device as claimed in claim 1, wherein the two component (2, 3) are arranged on a mounting bracket (5), which is firmly fixed to the vehicle.

5. The device as claimed in claim 1, wherein at least one transversely flexible shim (12, 13), which is fixed to the steering column casing tube, is arranged on the clamping bolt (6) next to an exterior (10, 11) of at least one of the components (2, 3).
